(19) United States
(12) Patent Application Publication
(10) Pub. No.: US 2026/0274428 A1
(43) Pub. Date: Sep. 17, 2026

(54) COOLING DEVICE AND FLYING OBJECT

(71) Applicant: HONDA MOTOR CO., LTD., Tokyo (JP)

(72) Inventor: Shingo Tanaka, Asaka-shi, Saitama-ken (JP)

(21) Appl. No.: 19/052,981

(22) Filed: Feb. 13, 2025

(30) Foreign Application Priority Data
Feb. 20, 2024 (JP) 2024-023502

(51) Int. Cl. B64D 33/08; H02K 9/19; B64D 27/34

(52) U.S. Cl. CPC B64D 33/08; H02K 9/19; B64D 27/34

(57) ABSTRACT

A cooling device includes a first reservoir portion, a flow path portion, a second reservoir portion, and a pump. The first reservoir portion stores oil. The flow path portion guides the oil stored in the first reservoir portion to a shaft via a first bearing, and guides the oil guided to the shaft to a second bearing. The second reservoir portion stores the oil guided to the second bearing. The pump sends, to the first reservoir portion, the oil that has reached the second reservoir portion.

### CROSS-REFERENCE TO RELATED APPLICATIONS

This application is based upon and claims the benefit of priority from Japanese Patent Application No. 2024-023502 filed on Feb. 20, 2024, the contents of which are incorporated herein by reference.

### BACKGROUND OF THE INVENTION

### FIELD OF THE INVENTION

The present disclosure relates to a cooling device and a flying object.

### DESCRIPTION OF THE RELATED ART

US 11613350 B1 discloses a cooling system for a rotating electric machine in an eVTOL aircraft. The cooling system includes an oil flow path and a heat exchanger. The oil flow path guides oil flowing out from the heat exchanger to the rotating electric machine via a gearbox, and guides the oil guided to the rotating electric machine to the heat exchanger via the gearbox.

### SUMMARY OF THE INVENTION

US 11613350 B1 merely discloses an oil flow path for guiding oil flowing out from a heat exchanger to a rotating electric machine via a gearbox and guiding the oil guided to the rotating electric machine to the heat exchanger via the gearbox. In recent years, there has been a demand for a cooling device capable of satisfactorily cooling a rotating electric machine.

The present invention has the object of solving the aforementioned problem.

According to a first aspect of the present disclosure, there is provided a cooling device that cools a rotating electric machine including a shaft disposed along a vertical direction, and a rotor fixed to the shaft, the cooling device comprising: a first reservoir portion configured to store oil, the first reservoir portion being provided above a first bearing that rotatably supports the shaft above the rotor; a flow path portion configured to guide the oil stored in the first reservoir portion to the shaft via the first bearing, and guide the oil guided to the shaft to a second bearing that rotatably supports the shaft below the rotor; a second reservoir portion provided below the second bearing and configured to store the oil guided to the second bearing; and a pump configured to send, to the first reservoir portion, the oil that has reached the second reservoir portion.

According to a second aspect of the present disclosure, there is provided a flying object comprising: the cooling device according to the first aspect; and the rotating electric machine according to the first aspect.

According to the above aspects, it is possible to provide a cooling device and a flying object that are capable of satisfactorily cooling the rotating electric machine.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a flying object;

FIG. 2 is a diagram showing the configuration of a rotating electric machine and a cooling device;

FIG. 3 is diagram showing a cross section taken along line III-III of FIG. 2; and

FIG. 4 is a diagram showing the flow of oil.

### DETAILED DESCRIPTION OF THE INVENTION

### 1. Overall Configuration of Flying Object 10

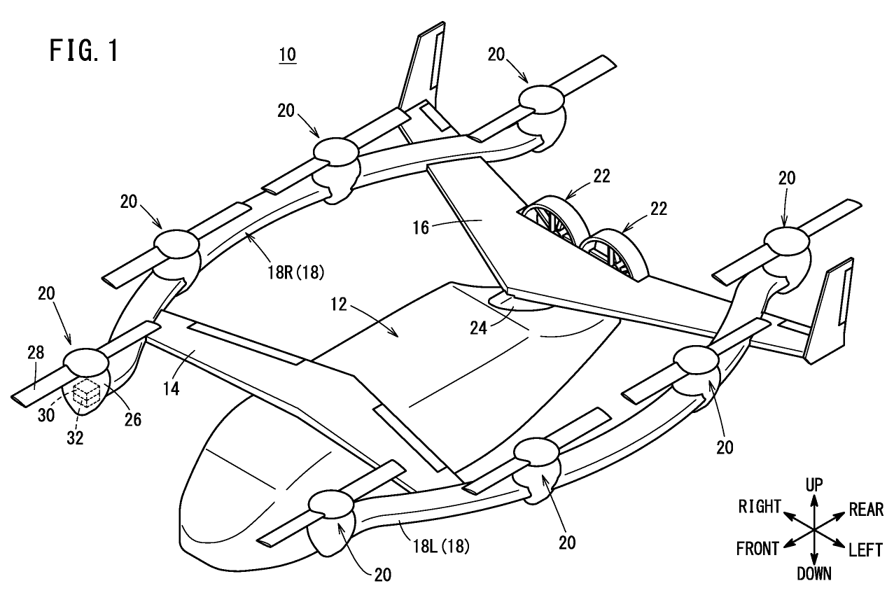

FIG. 1 is a perspective view of the flying object 10. In the present embodiment, the flying object 10 is an eVTOL aircraft, but is not limited thereto. For example, the flying object 10 may be a multicopter.

The flying object 10 includes a fuselage 12, a front wing 14, a rear wing 16, a plurality of booms 18, a plurality of takeoff and landing propeller devices 20, and a plurality of cruise propeller devices 22. The fuselage 12 is long in the front-rear direction. The front wing 14 is disposed forward of an intermediate portion of the fuselage 12 in the front-rear direction. The front wing 14 is connected to an upper portion of the fuselage 12. The rear wing 16 is disposed rearward of the intermediate portion of the fuselage 12 in the front-rear direction. The rear wing 16 is connected to the fuselage 12 via a pylon 24.

The plurality of booms 18 extend in the front-rear direction. The plurality of booms 18 include a right boom 18R and a left boom 18L. The right boom 18R is disposed on the right side of the fuselage 12. The right boom 18R is curved rightward in an arc shape. The right boom 18R is connected to a right wing tip of the front wing 14 and is connected to a right wing of the rear wing 16. The left boom 18L is disposed on the left side of the fuselage 12. The left boom 18L is curved leftward in an arc shape. The left boom 18L is connected to a left wing tip of the front wing 14 and is connected to a left wing of the rear wing 16. It should be noted that the right boom 18R and the left boom 18L may have a straight shape.

Each boom 18 includes the plurality of propeller devices 20. In the present embodiment, each boom 18 includes four propeller devices 20. It should be noted that each boom 18 may include two, three, five or more propeller devices 20. In each boom 18, the four propeller devices 20 are arranged at intervals in the extending direction of the boom 18.

Each of the plurality of propeller devices 20 includes an accommodating portion 26, a propeller 28, a rotating electric machine 30, and a cooling device 32, and the accommodating portions 26, the propellers 28, the rotating electric machines 30, and the cooling devices 32 respectively have the same structure. The accommodating portion 26 is configured to include a frame serving as a framework of the boom 18, and a fairing that covers the frame. The accommodating portion 26 accommodates the rotating electric machine 30 and the cooling device 32. The propeller 28 is located above the accommodating portion 26 and is rotatably attached to the accommodating portion 26. The rotating electric machine 30 rotates the propeller 28. The cooling device 32 cools the rotating electric machine 30.

The fuselage 12 includes the plurality of propeller devices 22. In the present embodiment, the fuselage 12 includes two propeller devices 22. The fuselage 12 may include one or three or more propeller devices 22. The two propeller devices 22 are arranged side by side in the left-right direction at a rear end portion of the fuselage 12.

### 2. Configuration of Rotating Electric Machine 30 and Cooling Device 32

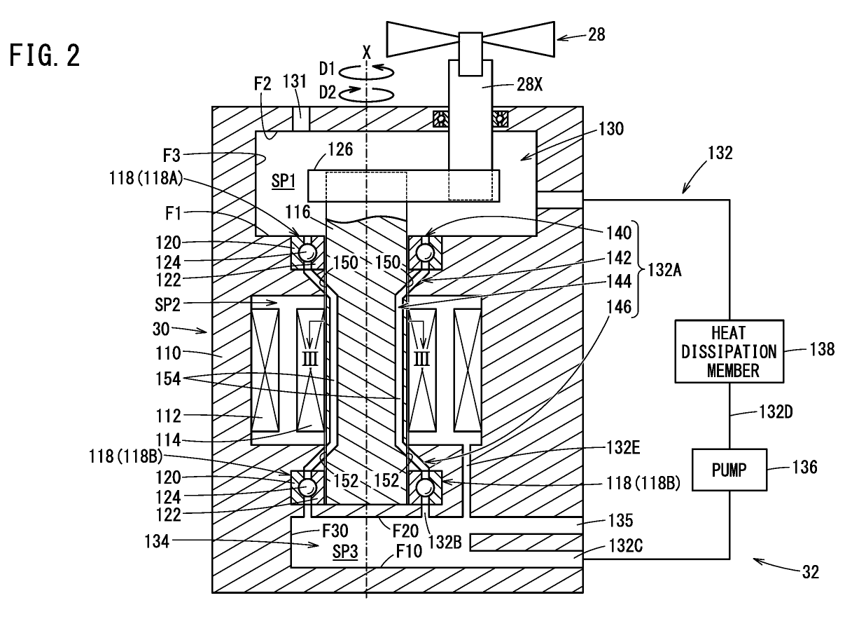

FIG. 2 is a diagram showing the configuration of the rotating electric machine 30 and the cooling device 32. The rotating electric machine 30 is fixed in a state where an axis (rotation center) X of the rotating electric machine 30 lies along the vertical direction. For example, the rotating electric machine 30 is fixed to the frame of the accommodating portion 26 (see FIG. 1). The rotating electric machine 30 is supplied with driving electric power from a power supply via an inverter circuit. The rotating electric machine 30 rotates about the axis X in a first rotational direction D1 or a second rotational direction D2 in response to the driving electric power. The rotating electric machine 30 includes a housing 110, a stator 112, a rotor 114, a shaft 116, and two bearings 118.

The housing 110 is formed by combining a plurality of members. The housing 110 accommodates the stator 112, the rotor 114, and the shaft 116. The stator 112 is fixed to the housing 110. The rotor 114 is disposed inside the stator 112 and is fixed to the shaft 116. The rotor 114 rotates in response to the driving electric power supplied from the power supply.

The shaft 116 extends along the vertical direction. The shaft 116 is rotatably supported by the housing 110 via the two bearings 118. The shaft 116 rotates integrally with the rotation of the rotor 114. An upper end portion of the shaft 116 is located within a gearbox 126. The gearbox 126 includes a plurality of gears (not shown) that couple the shaft 116 of the rotating electric machine 30 to a propeller rotating shaft 28X provided on the propeller 28. The plurality of gears reduce the rotational speed of the shaft 116 and transmit power to the propeller rotating shaft 28X.

Each of the two bearings 118 includes an outer ring 120, an inner ring 122, and rolling elements 124. One of the two bearings 118 is a first bearing 118A that rotatably supports the shaft 116 above the rotor 114. The other of the two bearings 118 is a second bearing 118B that rotatably supports the shaft 116 below the rotor 114.

The cooling device 32 is a device that cools the rotating electric machine 30. The cooling device 32 includes a first reservoir portion 130, an oil flow path 132, a second reservoir portion 134, a pump 136, and a heat dissipation member 138.

The first reservoir portion 130 is a portion that stores oil. In the present embodiment, the oil can function as a lubricating oil for the gearbox 126 and the bearings 118, and can also function as a cooling medium for cooling the rotating electric machine 30. The first reservoir portion 130 is provided above the first bearing 118A. The first reservoir portion 130 is provided inside the housing 110, but may be provided outside the housing 110.

The first reservoir portion 130 includes a reservoir space SP1 for storing oil. The reservoir space SP1 is surrounded by a bottom surface F1 of the first reservoir portion 130, an upper surface F2 of the first reservoir portion 130, and a circumferential side surface F3 of the first reservoir portion 130. The reservoir space SP1 is located above an accommodating space SP2 for accommodating the stator 112 and the rotor 114.

The gearbox 126 is provided inside the first reservoir portion 130 (the reservoir space SP1). The oil stored inside the first reservoir portion 130 is supplied to the gearbox 126. The liquid level of the oil stored inside the first reservoir portion 130 is located at least above a bottom surface of the gearbox 126. Preferably, the liquid level of the oil stored inside the first reservoir portion 130 is located above the gearbox 126. An air layer is formed above the liquid level of the oil stored inside the first reservoir portion 130. That is, an air layer is present inside the first reservoir portion 130.

A first air vent passage 131 is connected to the first reservoir portion 130. The first air vent passage 131 allows communication between the inside of the first reservoir portion 130 and the outside of the first reservoir portion 130 (the housing 110).

The oil flow path 132 is a flow path for allowing oil to flow therethrough. The oil flow path 132 includes five flow path portions 132A, 132B, 132C, 132D, and 132E. The flow path portion 132A guides the oil stored in the first reservoir portion 130 to the shaft 116 via the first bearing 118A, and guides the oil guided to the shaft 116 to the second bearing 118B. The flow path portion 132B guides the oil guided to the second bearing 118B to the second reservoir portion 134. The flow path portion 132C guides the oil guided to the second reservoir portion 134 to the pump 136. The flow path portion 132D guides, to the first reservoir portion 130, the oil sent from the pump 136. The flow path portion 132E guides the oil in the accommodating space SP2 to the second reservoir portion 134.

The second reservoir portion 134 is a portion that stores oil. The second reservoir portion 134 is provided below the second bearing 118B. The second reservoir portion 134 is provided inside the housing 110, but may be provided outside the housing 110.

The second reservoir portion 134 includes a reservoir space SP3 for storing oil. The reservoir space SP3 is surrounded by a bottom surface F10 of the second reservoir portion 134, an upper surface F20 of the second reservoir portion 134, and a circumferential side surface F30 of the second reservoir portion 134. The reservoir space SP3 is located below the accommodating space SP2. One end portion of the flow path portion 132C is connected to a lower portion of the circumferential side surface F30 of the second reservoir portion 134.

A second air vent passage 135 is connected to the second reservoir portion 134. The second air vent passage 135 allows communication between the inside of the second reservoir portion 134 and the outside of the second reservoir portion 134 (the housing 110). A portion of the second air vent passage 135 that opens to the second reservoir portion 134 is located above a portion of the flow path portion 132C that opens to the second reservoir portion 134. The second air vent passage 135 may not be provided.

The oil flows into the interior of the second reservoir portion 134 (the reservoir space SP3) from the second bearing 118B. The liquid level of the oil stored inside the second reservoir portion 134 is located between the portion of the second air vent passage 135 that opens to the second reservoir portion 134 and the portion of the flow path portion 132C that opens to the second reservoir portion 134. An air layer is formed above the liquid level of the oil stored inside the second reservoir portion 134. That is, an air layer is present inside the second reservoir portion 134. It should be noted that, in a case where the second air vent passage 135 is not provided, there is a possibility that the air layer is not present inside the second reservoir portion 134.

The pump 136 sucks oil from the flow path portion 132C and sends the sucked oil to the flow path portion 132D. The pump 136 is provided outside the housing 110. The pump 136 is fixed to the frame in the accommodating portion 26 (see FIG. 1), for example.

The heat dissipation member 138 is a member that dissipates heat of the oil to the outside. The heat dissipation member 138 may be a radiator. The heat dissipation member 138 is provided outside the housing 110. The heat dissipation member 138 is fixed to the frame in the accommodating portion 26 (see FIG. 1), for example. The heat dissipation member 138 is disposed on the flow path portion 132D, but may be disposed on the flow path portion 132C.

The flow path portion 132A of the oil flow path 132 described above is constituted by a first partial flow path 140, a second partial flow path 142, a third partial flow path 144, and a fourth partial flow path 146.

The first partial flow path 140 includes a part of the first bearing 118A. More specifically, one end (an upstream end) of the first partial flow path 140 includes a portion between the outer ring 120 of the first bearing 118A and the inner ring 122 of the first bearing 118A. At an upper end of the first bearing 118A, a portion between the outer ring 120 and the inner ring 122 opens to the bottom surface F1 of the first reservoir portion 130.

The second partial flow path 142 is a partial flow path that guides the oil that has reached the first bearing 118A to the shaft 116. One end (an upstream end) of the second partial flow path 142 is connected to a portion between the outer ring 120 and the inner ring 122 at a lower end of the first bearing 118A. The other end (a downstream end) of the second partial flow path 142 opens to a gap between an outer circumferential surface of the shaft 116 and the housing 110. In the present embodiment, the second partial flow path 142 is formed in the housing 110, but the present invention is not limited thereto.

The third partial flow path 144 is a partial flow path formed in the shaft 116. The third partial flow path 144 includes an inlet 150, an outlet 152, and an internal hollow part 154.

The inlet 150 is an opening for introducing the oil that has passed through the first bearing 118A. The inlet 150 is located in a portion of a side surface of the shaft 116, the portion being below the first bearing 118A. The inlet 150 is formed in plurality at intervals in the circumferential direction of the shaft 116. The inlets 150 periodically face the downstream end of the second partial flow path 142 in accordance with the rotation of the shaft 116. In a state where the inlet 150 and the downstream end of the second partial flow path 142 face each other, the inlet 150 and the second partial flow path 142 communicate with each other.

One of the plurality of inlets 150 may face the downstream end of the second partial flow path 142 in a state where the shaft 116 is stopped. The inlet 150 may be formed continuously in an annular shape in the circumferential direction of the shaft 116. In a case where the inlet 150 is formed continuously in an annular shape in the circumferential direction of the shaft 116, the inlet 150 faces the downstream end of the second partial flow path 142 regardless of the rotation of the shaft 116.

The outlet 152 is a port for discharging the oil introduced from the inlet 150. The outlet 152 is located in a portion of the side surface of the shaft 116, the portion being between the inlet 150 and the second bearing 118B. The outlet 152 is formed in plurality at intervals in the circumferential direction of the shaft 116. The number of the outlets 152 is the same as the number of the inlets 150. The outlets 152 periodically face an upstream end of the fourth partial flow path 146 in accordance with the rotation of the shaft 116.

One of the plurality of outlets 152 may face the upstream end of the fourth partial flow path 146 in a state where the shaft 116 is located at the initial position. Further, the outlet 152 may be formed continuously in an annular shape in the circumferential direction of the shaft 116. In this case, the outlet 152 faces the upstream end of the fourth partial flow path 146 regardless of the rotation of the shaft 116. In a state where the outlet 152 and the upstream end of the fourth partial flow path 146 face each other, the outlet 152 and the fourth partial flow path 146 communicate with each other.

The internal hollow part 154 allows communication between the inlet 150 and the outlet 152. The internal hollow part 154 is formed in plurality at intervals in the circumferential direction of the shaft 116. The number of the internal hollow parts 154 is the same as the number of the inlets 150 and the number of the outlets 152. One end (an upstream end) of one internal hollow part 154 is connected to one inlet 150. The other end (a downstream end) of one internal hollow part 154 is connected to one outlet 152.

The number of the internal hollow parts 154 may be one. In this case, the upstream end of the internal hollow part 154 is connected to the plurality of inlets 150. Further, the downstream end of the internal hollow part 154 is connected to the plurality of outlets 152.

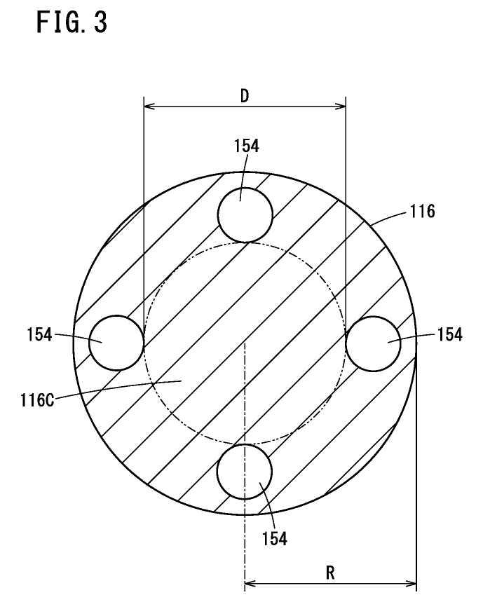

FIG. 3 is a diagram showing a cross section taken along line III-III of FIG. 2. The plurality of internal hollow parts 154 are formed in a region of the shaft 116 excluding a central portion 116C. The outer shape of the central portion 116C may be an inscribed circle that is inscribed in the plurality of internal hollow parts 154 in the cross section orthogonal to the axis X of the shaft 116. A diameter D of the central portion 116C is equal to or larger than a radius R of the shaft 116.

As shown in FIG. 2, the fourth partial flow path 146 is a partial flow path that guides, to the second bearing 118B, the oil discharged from the outlet 152. One end (an upstream end) of the fourth partial flow path 146 opens to a gap between the outer circumferential surface of the shaft 116 and the housing 110. The other end (a downstream end) of the fourth partial flow path 146 opens at a portion between the outer ring 120 and the inner ring 122 at an upper end of the second bearing 118B. In the present embodiment, the fourth partial flow path 146 is formed in the housing 110, but the present invention is not limited to this.

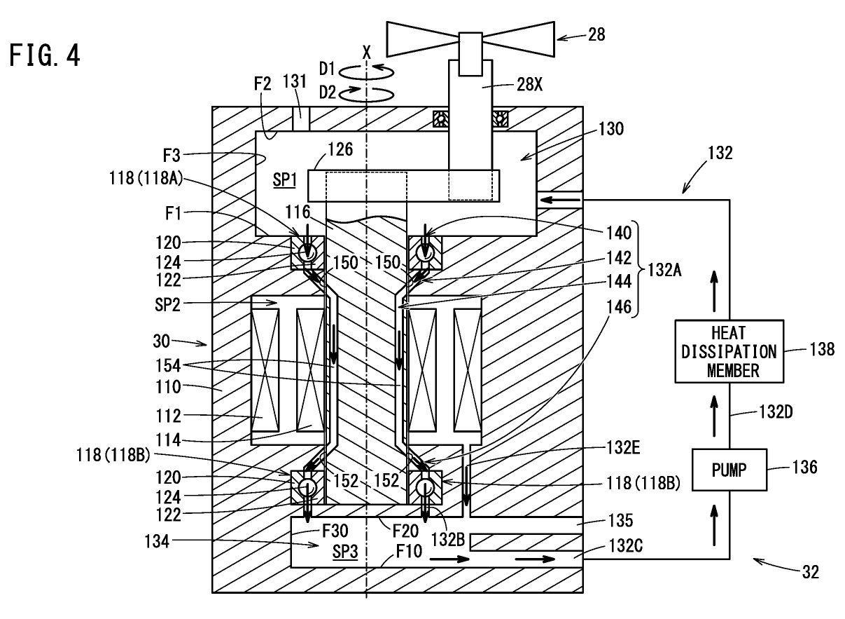

FIG. 4 is a diagram showing the flow of oil. The oil stored in the first reservoir portion 130 flows through the flow path portion 132A and reaches the second bearing 118B by gravity.

First, the oil stored in the first reservoir portion 130 flows through the first partial flow path 140 into the portion between the outer ring 120 and the inner ring 122 at the upper end of the first bearing 118A. The oil that has flowed into the portion between the outer ring 120 and the inner ring 122 lubricates the first bearing 118A. The oil that lubricates the first bearing 118A flows into the second partial flow path 142 from the lower end of the first bearing 118A, and flows through the second partial flow path 142. The oil flowing through the second partial flow path 142 flows out from the downstream end of the second partial flow path 142 and flows into the inlet 150 of the shaft 116 that faces the downstream end. The oil that has flowed into the inlet 150 flows through the internal hollow part 154. The oil flowing through the internal hollow part 154 flows out from the outlet 152 and flows into the upstream end of the fourth partial flow path 146 that faces the outlet 152. The oil that has flowed into the upstream end of the fourth partial flow path 146 flows through the fourth partial flow path 146 and reaches the second bearing 118B.

The oil that has reached the second bearing 118B lubricates the second bearing 118B. The oil that lubricates the second bearing 118B flows from a lower end of the second bearing 118B to the flow path portion 132B and is then stored in the second reservoir portion 134. The oil stored in the second reservoir portion 134 is sent to the first reservoir portion 130 when the pump 136 is driven. The pump 136 is driven when the rotating electric machine 30 is driven, for example.

The rotating electric machine 30 generates heat by being driven. In particular, the amount of heat generated by the rotor 114 is larger than that generated by the other parts of the rotating electric machine 30 than the rotor 114. The heat generated from the rotor 114 is absorbed by oil flowing through the internal hollow parts 154 formed in the shaft 116. As a result, the rotor 114 is cooled. The oil that has absorbed the heat is returned to the first reservoir portion 130 after the heat thereof is dissipated in the heat dissipation member 138.

In a state where the shaft 116 is being rotated by the driving of the rotating electric machine 30, a first state and a second state may occur alternately. The first state is a state where the inlet 150 of the shaft 116 and the downstream end of the second partial flow path 142 face each other. The second state is a state where the inlet 150 of the shaft 116 and the downstream end of the second partial flow path 142 do not face each other. In addition, in a state where the rotating electric machine 30 is stopped, the first state or the second state continues. When the oil flows out from the downstream end of the second partial flow path 142 in the second state, the oil flows along the outer circumferential surface of the shaft 116 without flowing into the inlet 150.

The oil flowing along the outer circumferential surface of the shaft 116 is stored in the second reservoir portion 134 via the flow path portion 132E.

As described above, the cooling device 32 of the present embodiment includes the first reservoir portion 130, the flow path portion 132A, the second reservoir portion 134, and the pump 136. The first reservoir portion 130 stores oil. The flow path portion 132A guides the oil stored in the first reservoir portion 130 to the shaft 116 via the first bearing 118A, and guides the oil guided to the shaft 116 to the second bearing 118B. The second reservoir portion 134 stores the oil guided to the second bearing 118B. The pump 136 sends the oil that has reached the second reservoir portion 134 to the first reservoir portion 130. As a result, the bearings 118 can be lubricated, and the rotor 114 can be cooled. Since it is not necessary to separately provide equipment for circulating oil for lubricating the bearings 118 and equipment for circulating oil used for cooling the rotor 114, the cooling device 32 can be reduced in size.

Further, in the present embodiment, the first air vent passage 131 is connected to the first reservoir portion 130. As a result, the oil can be made to flow satisfactorily in the flow path portion 132A. In a case where the second air vent passage 135 is connected to the second reservoir portion 134 in addition to the first air vent passage 131 being connected to the first reservoir portion 130, the oil can be made to flow more satisfactorily in the flow path portion 132A.

Furthermore, in the present embodiment, the gearbox 126 is provided inside the first reservoir portion 130. As a result, the oil that lubricates the gearbox 126 can be used as the lubricating oil for the bearings 118 and the cooling medium for the rotor 114. Since it is not necessary to separately provide equipment for circulating oil for lubricating the gearbox 126 and equipment for circulating oil used for lubricating the bearings 118 and cooling the rotor 114, the cooling device 32 can be reduced in size.

In addition, in the present embodiment, the inlets 150, the outlets 152, and the internal hollow parts 154 are formed in the shaft 116. As a result, the heat generated from the rotor 114 can be absorbed by the oil flowing through the internal hollow parts 154, and the rotor 114 can be cooled. That is, according to the present embodiment, the rotor 114 can be sufficiently cooled.

Moreover, in the present embodiment, the inlets 150 are formed in a portion of the side surface of the shaft 116, the portion being located below the first bearing 118A. The outlets 152 are formed in a portion of the side surface of the shaft 116, the portion being located between the inlets 150 and the second bearing 118B. As a result, the oil can be made to flow inside the shaft 116 by gravity.

Further, in the present embodiment, the plurality of inlets 150, the plurality of outlets 152, and the plurality of internal hollow parts 154 are respectively formed at intervals in the circumferential direction of the shaft 116. As a result, oil can be easily made to flow through the inside of the shaft 116.

Furthermore, in the present embodiment, the plurality of internal hollow parts 154 are formed in a region of the shaft 116 excluding the central portion 116C. This allows the internal hollow parts 154 to be closer to the rotor 114 than in a case where the central portion 116C is the internal hollow part 154. Therefore, the efficiency of cooling the rotor 114 can be increased.

In addition, in the present embodiment, the diameter D of the central portion 116C is equal to or larger than the radius R of the shaft 116. As a result, it is possible to make the oil flow through the inside of the shaft 116 while suppressing a decrease in durability of the shaft 116.

The following supplementary notes are further disclosed in relation to the above-described embodiment.

### Supplementary Note 1

The cooling device (32) of the present disclosure is a cooling device that cools the rotating electric machine (30) including the shaft (116) disposed along a vertical direction, and the rotor (114) fixed to the shaft, the cooling device including: the first reservoir portion (130) configured to store oil, the first reservoir portion being provided above the first bearing (118A) that rotatably supports the shaft above the rotor; the flow path portion (132A) configured to guide the oil stored in the first reservoir portion to the shaft via the first bearing, and guide the oil guided to the shaft to the second bearing (118B) that rotatably supports the shaft below the rotor; the second reservoir portion (134) provided below the second bearing and configured to store the oil guided to the second bearing; and the pump (136) configured to send, to the first reservoir portion, the oil that has reached the second reservoir portion.

### Supplementary Note 2

In the cooling device according to Supplementary Note 1, the first air vent passage (131) configured to allow communication between the inside of the first reservoir portion and the outside of the first reservoir portion may be connected to the first reservoir portion.

### Supplementary Note 3

In the cooling device according to Supplementary Note 2, the second air vent passage (135) configured to allow communication between the inside of the second reservoir portion and the outside of the second reservoir portion may be connected to the second reservoir portion.

### Supplementary Note 4

In the cooling device according to Supplementary Note 1, the gearbox (126) may be provided inside the first reservoir portion.

### Supplementary Note 5

In the cooling device according to Supplementary Note 1, the shaft may be provided with the inlet (150) through which the oil having passed through the first bearing is introduced, the outlet (152) through which the oil introduced from the inlet is discharged, and the internal hollow part (154) communicating with the inlet and the outlet.

### Supplementary Note 6

In the cooling device according to Supplementary Note 5, the inlet may be formed in a portion of the side surface of the shaft, the portion being located below the first bearing, and the outlet may be formed in a portion of the side surface of the shaft, the portion being located below the inlet.

### Supplementary Note 7

In the cooling device according to Supplementary Note 5, the inlet may comprise a plurality of the inlets formed at intervals in the circumferential direction of the shaft, the outlet may comprise a plurality of the outlets formed at intervals in the circumferential direction of the shaft, and the internal hollow part may comprise a plurality of the internal hollow parts formed at intervals in the circumferential direction of the shaft.

### Supplementary Note 8

In the cooling device according to Supplementary Note 7, the plurality of internal hollow parts may be formed in a region of the shaft excluding the central portion 116C.

### Supplementary Note 9

In the cooling device according to Supplementary Note 8, the diameter (D) of the central portion may be equal to or larger than the radius (R) of the shaft.

### Supplementary Note 10

The flying object (10) of the present disclosure includes the cooling device according to any one of Supplementary Notes 1 to 9, and the rotating electric machine according to any one of Supplementary Notes 1 to 9.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A cooling device that cools a rotating electric machine including a shaft disposed along a vertical direction, and a rotor fixed to the shaft, the cooling device comprising:
a first reservoir portion configured to store oil, the first reservoir portion being provided above a first bearing that rotatably supports the shaft above the rotor;
a flow path portion configured to guide the oil stored in the first reservoir portion to the shaft via the first bearing, and guide the oil guided to the shaft to a second bearing that rotatably supports the shaft below the rotor;
a second reservoir portion provided below the second bearing and configured to store the oil guided to the second bearing; and
a pump configured to send, to the first reservoir portion, the oil that has reached the second reservoir portion.

2. The cooling device according to claim 1, wherein
a first air vent passage configured to allow communication between an inside of the first reservoir portion and an outside of the first reservoir portion is connected to the first reservoir portion.

3. The cooling device according to claim 2, wherein
a second air vent passage configured to allow communication between an inside of the second reservoir portion and an outside of the second reservoir portion is connected to the second reservoir portion.

4. The cooling device according to claim 1, wherein
a gearbox is provided inside the first reservoir portion.

5. The cooling device according to claim 1, wherein
the shaft is provided with an inlet through which the oil having passed through the first bearing is introduced, an outlet through which the oil introduced from the inlet is discharged, and an internal hollow part communicating with the inlet and the outlet.

6. The cooling device according to claim 5, wherein
the inlet is formed in a portion of a side surface of the shaft, the portion being located below the first bearing, and
the outlet is formed in a portion of the side surface of the shaft, the portion being located below the inlet.

7. The cooling device according to claim 5, wherein
the inlet comprises a plurality of the inlets formed at intervals in a circumferential direction of the shaft, the outlet comprises a plurality of the outlets formed at intervals in the circumferential direction of the shaft, and the internal hollow part comprises a plurality of the internal hollow parts formed at intervals in the circumferential direction of the shaft.

8. The cooling device according to claim 7, wherein
the plurality of internal hollow parts are formed in a region of the shaft excluding a central portion of the shaft.

9. The cooling device according to claim 8, wherein
a diameter of the central portion is equal to or larger than a radius of the shaft.

10. A flying object comprising:
the cooling device according to claim 1; and
the rotating electric machine according to claim 1.
